(19) United States
(12) Patent Application Publication
(10) Pub. No.: US 2015/0107149 A1
(43) Pub. Date: Apr. 23, 2015

(54) BUCKET CONTAINING FLOATING NET FOR FISHING AND A CADDY FOR CARRYING THE SAME

(71) Applicant: Sanford E. Garrett, Kansas City, KS (US)

(72) Inventor: Sanford E. Garrett, Kansas City, KS (US)

(21) Appl. No.: 14/581,799

(22) Filed: Dec. 23, 2014

Related U.S. Application Data
(63) Continuation-in-part of application No. 12/943,866, filed on Nov. 10, 2010, now abandoned.

(51) Int. Cl. A01K 97/22; A01K 74/00; A01K 75/04; A01K 97/10; B62B 1/26; A01K 97/04; A01K 97/20; A01K 99/00; B62B 1/10; A01K 71/00; A01K 97/06

(52) U.S. Cl. CPC A01K 97/22; A01K 71/00; A01K 74/00; A01K 75/04; A01K 97/10; A01K 97/06; A01K 97/04; A01K 97/20; A01K 99/00; B62B 1/10; B62B 1/262; B62B 1/264
USPC 43/55; 280/47.19; 297/129

(57) ABSTRACT

A fish keeping and organization system that includes a bucket for storing a floating net assembly and a caddy for carrying the same. The bucket may include a cushioned seat on a lid portion thereof to provide a seat for a user. The floating net assembly may be removed from the bucket and allowed to float in water. The floating net assembly may include a float ring on a top portion and a weighted lower ring to allow the net assembly to become elongated when disposed in water, such as a lake. A drawstring may be included at the lower end of the net assembly for easy removal of fish kept in the net. The caddy can include wheels and a handle for ease of movement, straps for securing the bucket, and fishing pole holders for storing and moving fishing poles.

### CROSS-REFERENCE TO RELATED APPLICATIONS

This application is a continuation-in-part of U.S. patent application Ser. No. 12/943,866, filed Nov. 10, 2010, the contents of which are herein incorporated by reference.

### BACKGROUND OF THE INVENTION

The present invention relates to buckets and caddies and, more particularly, to a bucket having a floating net adapted to be stored inside the bucket and a caddy for carrying the same as well as additional fishing gear.

Fishermen, either when fishing from shore or from a boat, need a way to keep their catch alive and fresh. While larger boats may include a live well, not all boats are so equipped. Even when equipped with a live well, the water therewithin may get warm and/or stale/dirty over time. Shore fishermen may contain their catch on a line or a chain with clips that attach to the fish through their mouth and gills. With these lines/chains, it may be difficult to change locations and these systems may harm the fish.

In competition fishing, the catch must be kept alive for weighing and measuring and then released. People participating in this sport require a way to keep their catch alive and healthy.

Moreover, fishermen need a way to carry their supplies, including poles, a supplies container, their catch, and the like. While carts, some similar to wagons, exist, many of these are not specifically design for fishing, and, if so designed, may not be configured to carry specific items in the given carrying space.

As can be seen, there is a need for a system for keeping a fishing catch alive and healthy while allowing the angler to easily move their supplies, and their fishing catch, from location to location.

### SUMMARY OF THE INVENTION

In one aspect of the present invention, a fish keeping system comprises a bucket having a container portion and a lid portion; a net assembly adapted to fit inside the bucket; a float ring attached to one end of the net assembly; a first ring attached to a first end of a net extending from the float ring; and a second ring attached to the net proximal to an opening at a second end of the net.

In another aspect of the present invention, a fishing caddy comprises an upper tube assembly having a handle for moving the fishing caddy; a lower tube assembly connected to and extending from the upper tube assembly; first and second wheels; a wheel strut assembly extending from the lower tube assembly to the first and second wheels; an upper bucket bracket assembly attached to the lower tube assembly, the upper bucket bracket assembly having a strap adapted to fit about a bucket; a lower bucket bracket assembly attached to the lower tube assembly, below the upper bucket bracket assembly, the lower bucket bracket assembly having a base for supporting the bucket when disposed therein and a strap adapted to fit about the bucket, the base further resting against a surface, with the first and second wheels, when the fishing caddy is resting upright on the surface; and one or more fishing rod holders attached to the caddy.

In a further aspect of the present invention, a fishing system comprises a bucketbasket comprising a bucket having a container portion and a lid portion; a net assembly adapted to fit inside the bucket; a float ring attached to one end of the net assembly; a first ring attached to a first end of a net extending from the float ring; a second ring attached to the net proximal to an opening at a second end of the net; a cushioned seat on an exterior surface of the lid; a handle for carrying the system; and a net assembly handle attached to and extending from the net assembly; and a fishing caddy comprising an upper tube assembly having a handle for moving the fishing caddy; a lower tube assembly connected to and extending from the upper tube assembly; first and second wheels; a wheel strut assembly extending from the lower tube assembly to the first and second wheels; an upper bucket bracket assembly attached to the lower tube assembly, the upper bucket bracket assembly having a strap adapted to fit about the bucket; a lower bucket bracket assembly attached to the lower tube assembly, below the upper bucket bracket assembly, the lower bucket bracket assembly having a base for supporting the bucket when disposed therein and a strap adapted to fit about the bucket, the base further resting against a surface, with the first and second wheels, when the fishing caddy is resting upright on the surface; and one or more fishing rod holders attached to the caddy.

These and other features, aspects and advantages of the present invention will become better understood with reference to the following drawings, description and claims.

### BRIEF DESCRIPTION OF THE DRAWINGS

FIG. 1 is a perspective view of a bucketbasket in a closed position according to an embodiment of the present invention;

FIG. 2 is a perspective view of the bucketbasket of FIG. 1, in with its lid open;

FIG. 3 is an exploded view of the bucketbasket of FIG. 1, with a net assembly removed therefrom;

FIG. 4 is a top view of a net assembly according to an embodiment of the present invention;

FIG. 5 is a perspective view of the net assembly of FIG. 4;

FIG. 6 is a close-up view of a lower portion of the net assembly of FIG. 4;

FIG. 7 is a front perspective view of a fishing caddy, according to an exemplary embodiment of the present invention, configured to carry, for example, the bucketbasket of FIG. 1;

FIG. 8 is a side view of the fishing caddy of FIG. 7;

FIG. 9A is a perspective view of an upper tube assembly of the fishing caddy of FIG. 7;

FIG. 9B is a top view of the upper tube assembly of FIG. 9A;

FIG. 9C is a side view of the upper tube assembly of FIG. 9A;

FIG. 10A is a bottom view of a lower tube assembly of the fishing caddy of FIG. 7;

FIG. 10B is a side view of the lower tube assembly of FIG. 10A;

FIG. 10C is a top view of the lower tube assembly of FIG. 10A;

FIG. 11A is a perspective view of a rod holder assembly of the fishing caddy of FIG. 7;

FIG. 11B is a side view of the rod holder assembly of FIG. 11A;

FIG. 11C is a front view of the rod holder assembly of FIG. 11A;

FIG. 11D is a partial cross-sectional view of the rod holder assembly of FIG. 11A;

FIG. 12A is a perspective view of a lower bucket bracket assembly of the fishing caddy of FIG. 7;

FIG. 12B is a top view of the lower bucket bracket assembly of FIG. 12A;

FIG. 12C is a front view of the lower bucket bracket assembly of FIG. 12A;

FIG. 12D is a side view of the lower bucket bracket assembly of FIG. 12A;

FIG. 13A is a perspective view of an upper bucket bracket assembly of the fishing caddy of FIG. 7;

FIG. 13B is a top view of the upper bucket bracket assembly of FIG. 13A;

FIG. 13C is a front view of the upper bucket bracket assembly of FIG. 13A;

FIG. 13D is a side view of the upper bucket bracket assembly of FIG. 13A;

FIG. 14A is a perspective view of a wheel strut assembly of the fishing caddy of FIG. 7;

FIG. 14B is a side view of the wheel strut assembly of FIG. 14A;

FIG. 14C is a front view of the wheel strut assembly of FIG. 14A;

FIG. 14D is a top view of the wheel strut assembly of FIG. 14A;

FIG. 15A is a perspective view of a wheel strut lower bracket assembly of the fishing caddy of FIG. 7;

FIG. 15B is a top view of the wheel strut lower bracket assembly of FIG. 15A;

FIG. 15C is a side view of the wheel strut lower bracket assembly of FIG. 15A;

FIG. 15D is a rear view of the wheel strut lower bracket assembly of FIG. 15A;

FIG. 15E is a cross-sectional view taken along line 15-15 of FIG. 15B;

FIG. 16 is a side view of a caddie pack attached to the fishing caddy of FIG. 7; and

FIG. 17 is a front view of the caddie pack of FIG. 16, in an open configuration.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a fish keeping and organization system that includes a bucket for storing a floating net assembly and a caddy for carrying the same. The bucket may include a cushioned seat on a lid portion thereof to provide a seat for a user. The floating net assembly may be removed from the bucket and allowed to float in water. The floating net assembly may include a float ring on a top portion and a weighted lower ring to allow the net assembly to become elongated when disposed in water, such as a lake. A drawstring may be included at the lower end of the net assembly for easy removal of fish kept in the net. The net assembly may allow a fisherman to keep their catch in a more natural environment, without any physical restraint attached to the fish. The caddy can include wheels and a handle for ease of movement and straps for securing the bucket. Fishing pole holders can be disposed on the caddy for storing and moving fishing poles.

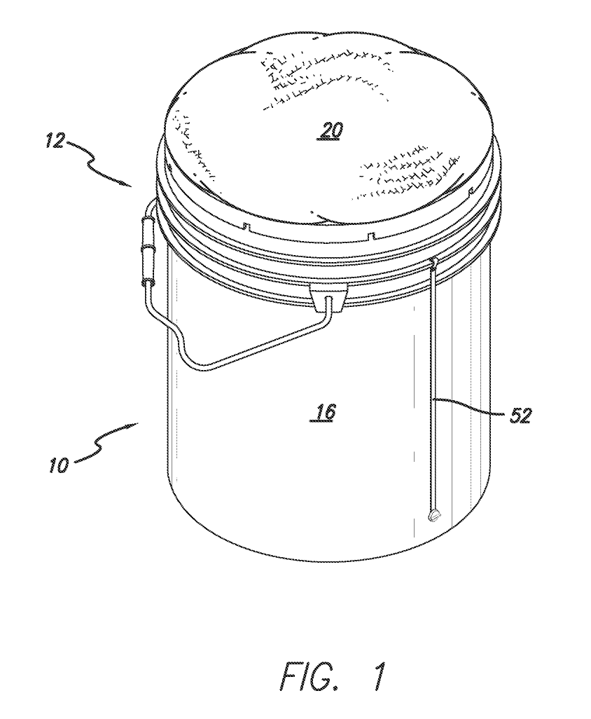

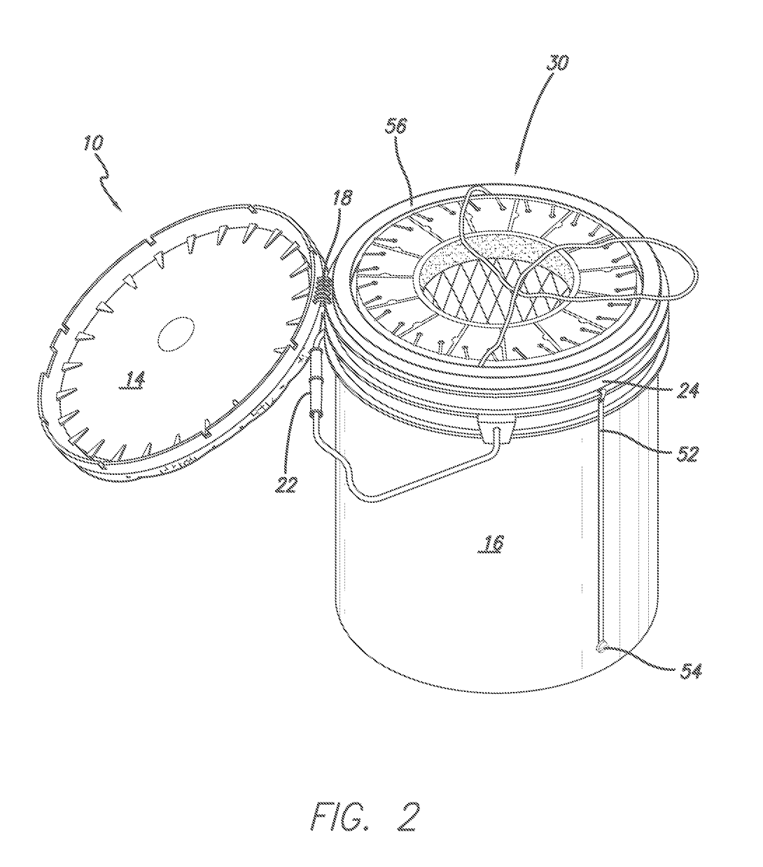

Referring to FIGS. 1 and 2, a bucketbasket 10 may include a bucket 12 having a lid 14 removable attached to a container 16. In some embodiments, the lid 14 may be attached to the container 16 with a hinge 18. The hinge 18 may be any type of hinge for attaching two components. For example, the hinge 18 may be formed from stitching that joins a portion of the lid 14 to a portion of the container 16. In other embodiments, the hinge may be a living hinge formed from a plastic material.

A seat 20 may be disposed on the outside surface of the lid 14. The seat 20 may be a cushioned seat for comfort of a user. The bucketbasket 10 may further include a handle 22 for portability of the bucketbasket 10. The handle 22 may be attached to the bucketbasket 10 by means known in art.

The bucket 12 may be of any suitable style, size and design. For example, the bucket 12 may be a conventional 5-gallon round pail. In other embodiments, the bucket 12 may be larger or smaller, depending on the needs of the user. For example, a smaller bucket 12 may be used by children, thereby providing a lower seat 20. A larger bucket 12, such as a 7-gallon pail, may be used by adults. The bucketbasket 10 may be colored and decorated according to the user's preferences. For example, when a family goes fishing, each person may have their own bucketbasket 10, each identified by, for example, a different color.

A net assembly 30, as described in greater detail below, may be disposed inside of the bucket 12. The net assembly 30 may include a top member (also referred to as top ring) 32 sized to rest on a lip 24 of the container 16, thereby preventing the net assembly 30 from collapsing inside of the container 16.

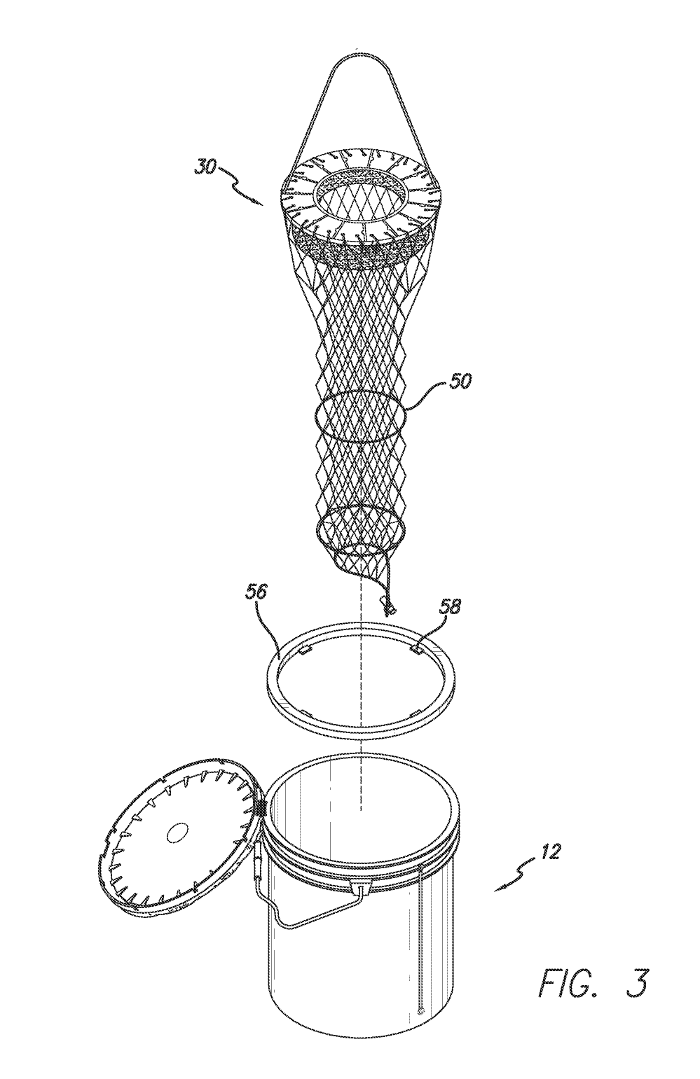

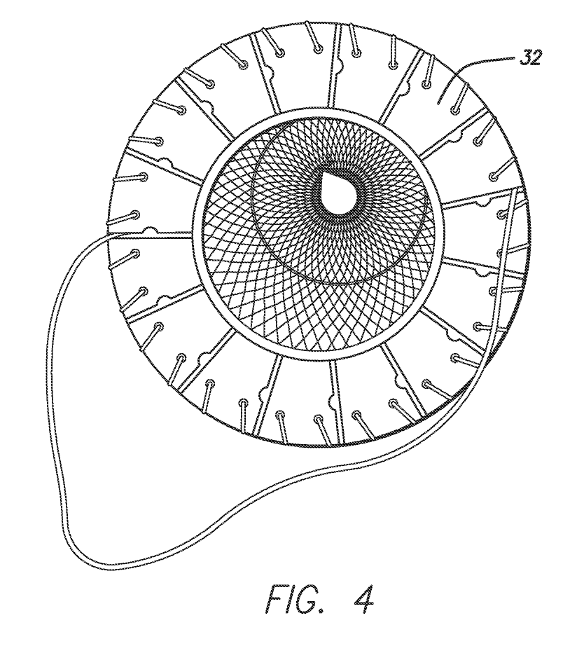

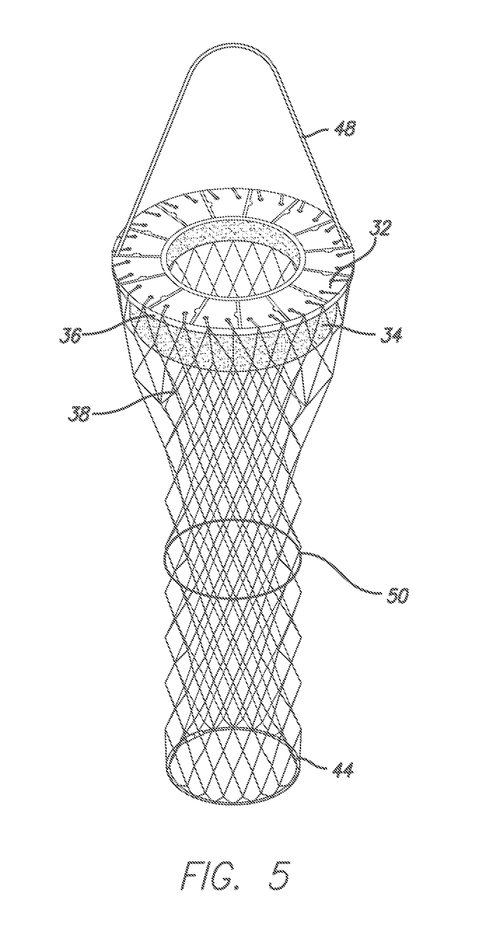

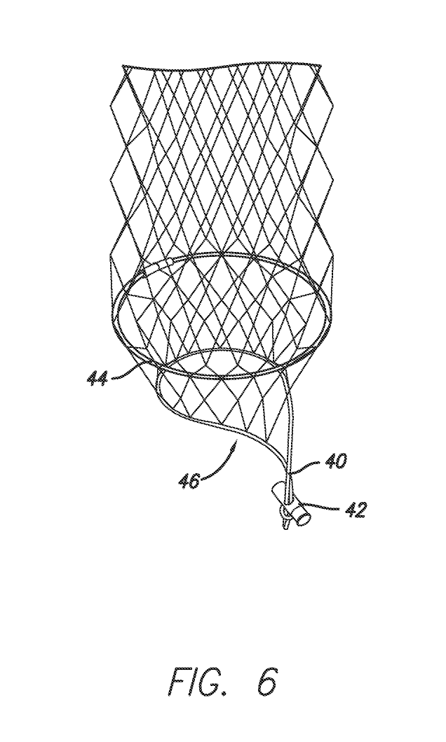

Referring now to FIGS. 3 through 5, the net assembly 30 includes a float ring 34 disposed at a top end of the net assembly 30. The float ring 34 is adapted to float in water. In one embodiment, the float ring 34 may be made of foam, such as Styrofoam. In other embodiments, the float ring 34 may be made of a hollow member, such as a hollow, round tubular member. This hollow member may be made of, for example, plastic. The top member 32 may be attached to the float ring 34. Alternatively, the top member 32 may be formed as a one-piece member with the float ring 34.

A ring 36 may be attached to the top member 32. The ring 36 may be a circular ring having an outside diameter smaller than an inside diameter of the container 16. The ring 36 may be made from solid plastic, hollow plastic, or metal, such as stainless steel.

A net 38 may be attached to the ring 36. The net 38, when expanded, may have a tubular shape with openings on each end. One open end of the net 38 may be aligned with an opening in the float ring 34. The other open end 46 of the net 38 may include a drawstring 40 for closing this open end. The drawstring 40 may include a drawstring catch 42 adapted to maintain the drawstring 40 in a closed position.

A lower ring 44 may be positioned in the net at a position proximal to the open end 46 of the net 38 having the drawstring 40. In some embodiments, the lower ring 44 may be disposed a distance from the open end 46 of the net 38 so that the drawstring 40 may close the open end 46. The lower ring 44 may have made of a material that has a density greater than the density of water. This design may allow the lower ring 44 to sink in water, thereby permitting the net assembly 30 to be fully extended (from the float ring 34 to the sunken lower ring 44) when placed in water.

The net 38 may be removable attached to each of the ring 36 and the lower ring 44 by, for example, tying, straps, tape and the like. This design may allow removal and replacement of the net 38, permitting new nets or differently sized nets to be installed in the net assembly 30.

A net assembly handle 48 may be attached to the ring 36. The handle 48 may allow placement and removal of the net assembly 30 into water. The handle 48 may also be used to attach the net assembly 30 to a boat, for example. As the boat moves, the net assembly 30 may move along with the boat in water.

The bucketbasket 10 may be used as a seat. In addition, the bucketbasket 10 may be used to store the net assembly 30, which may be removed from the bucket 12 and placed in the water (such as in a lake) to store caught fish. If the person fishing is on shore and wants to change locations, lake water may be partially filled in the bucket 12 and the net assembly may be lifted out of the water (with the fish therewith) and placed in the bucket 12. The bucketbasket 10 (with the fish and water inside) may be moved to another location and the net assembly 30 may be removed and placed in the water again. When fishing from a boat, the net assembly 30 may be attached to the boat (by the handle 48) and the floating ring 34 may float on the water, with the net 38 extending below the floating ring 34, under the water. When fish are caught, they may be placed into the net assembly 30.

As shown in FIG. 3, the net assembly 30, when extended, may be larger than the inside area of the bucket 12. This may give caught fish stored in the net assembly 30 room to swim about at various depths.

The bucketbasket 10 may also include an apron (not shown) around the bucket 12. The apron may hold, for example, fishing tackle. The bucketbasket 10 may not only be used for fish caught, but may also be used to hold bait fish, keeping them alive until they are ready for use.

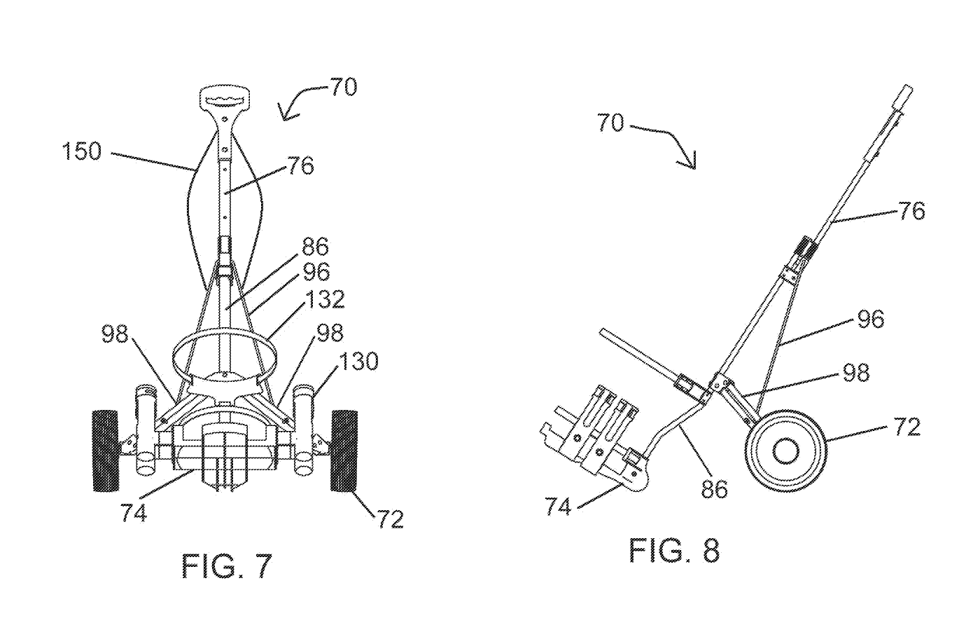

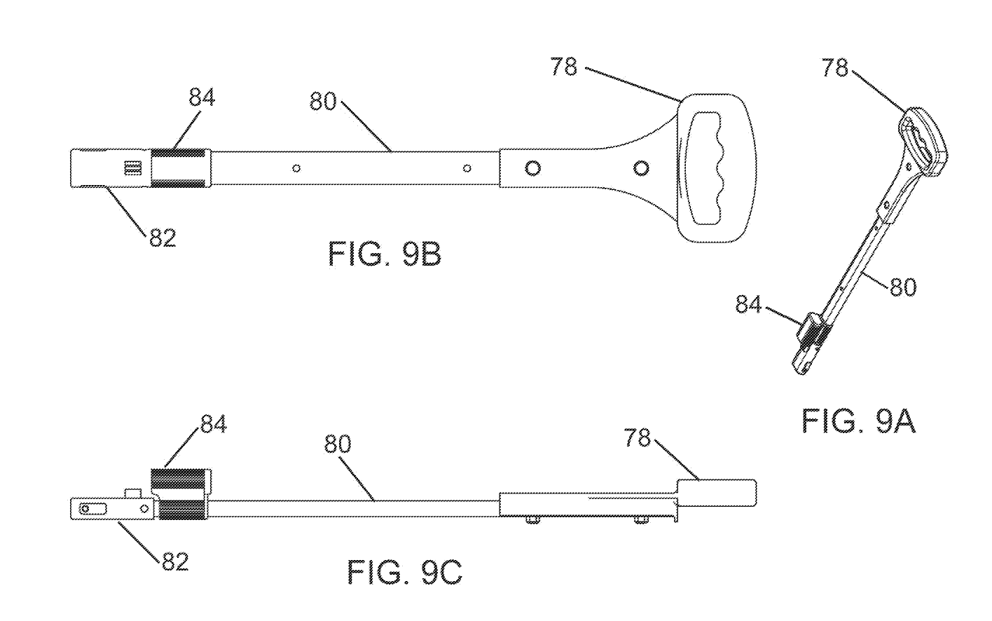

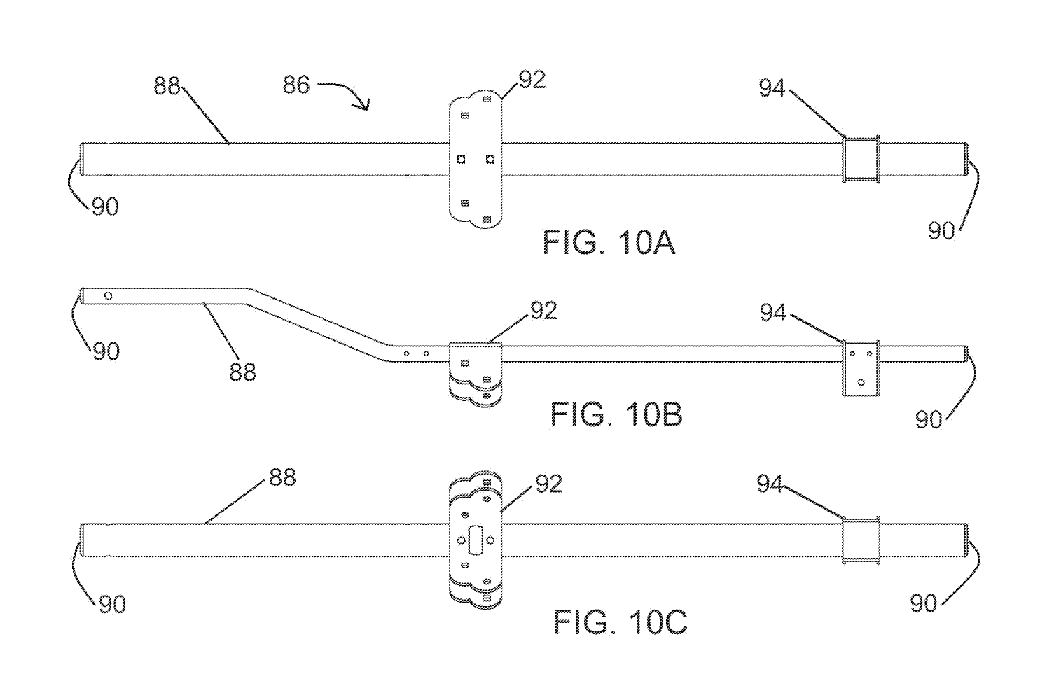

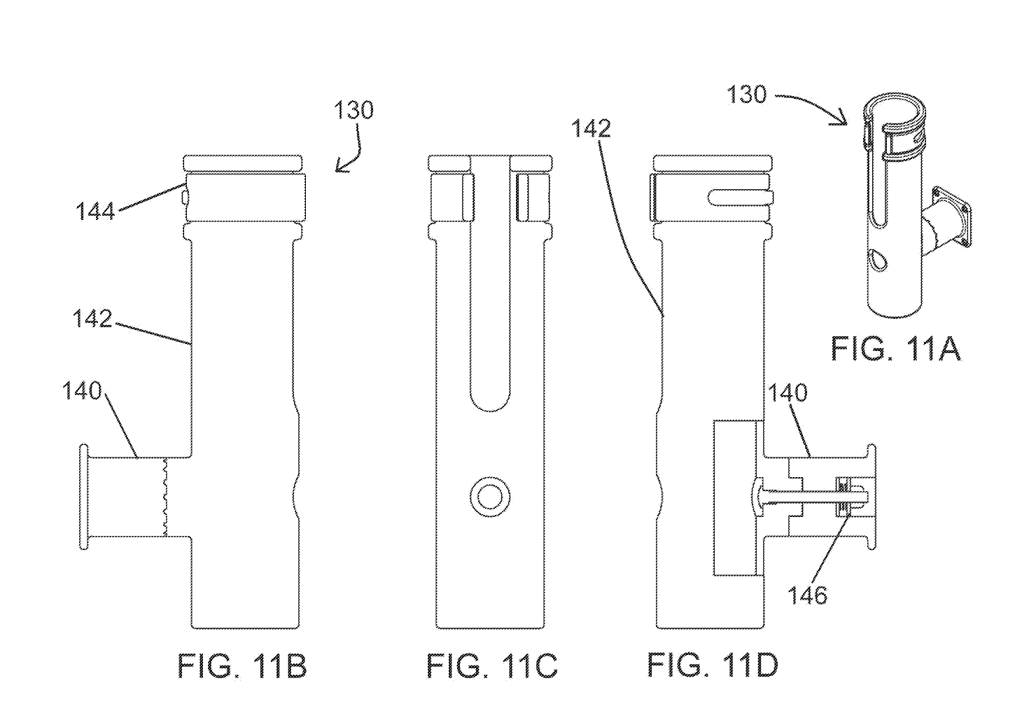

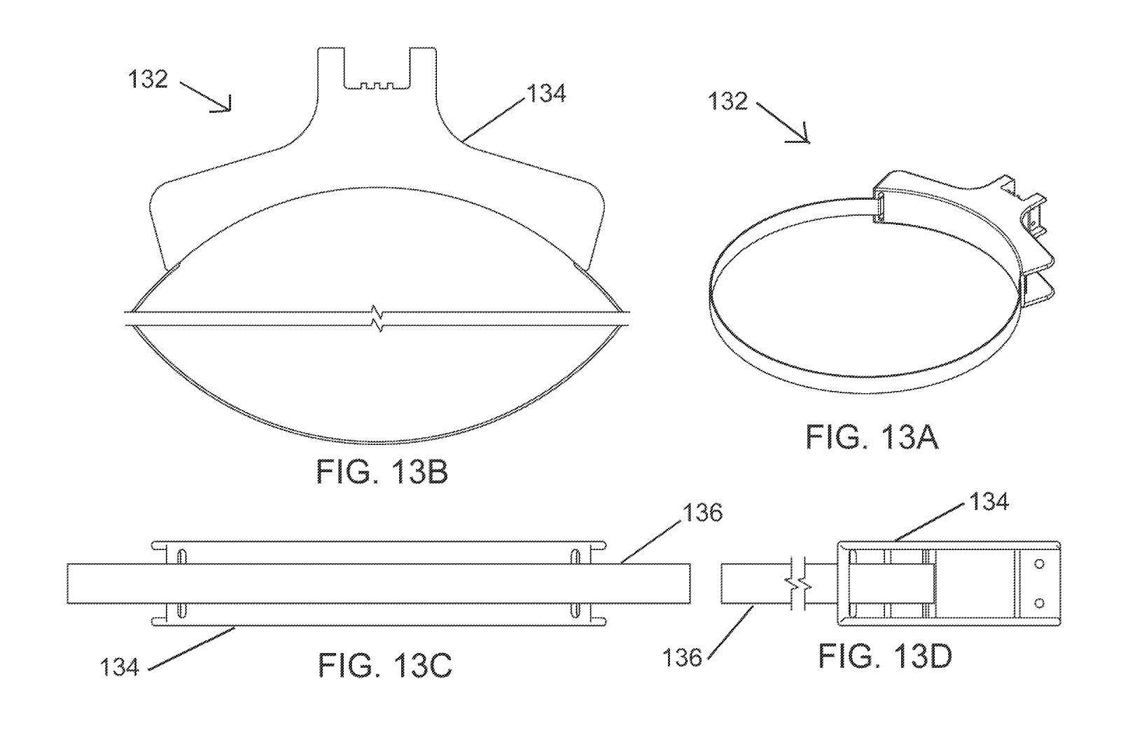

Referring now to FIGS. 7 through 15E, a caddy 70 can be used to support the bucketbasket 10 as well as other fishing supplies, such as fishing poles (not shown), nets, and the like.

The caddy 70 can be supported, at rest, in a triangular configuration, resting on two wheels 72 and a lower bucket bracket assembly 74. The caddy 70 can be designed, in some embodiments, to fold to a reduced footprint for storage, where the wheels 72 may move together from their spaced-apart, in-use position.

The caddy 70 can include an upper tube assembly 76 that includes a handle 78, an upper tube 80, an upper tube end cap 82 and a sliding cap 84. The sliding cap 84 can slide along the upper tube 80 and may also support a lower tube assembly 86 having a lower tube 88 with end caps 90 on each end thereof. The lower tube assembly 86 can further include a wheel strut bracket 92 and a brace arm support 94.

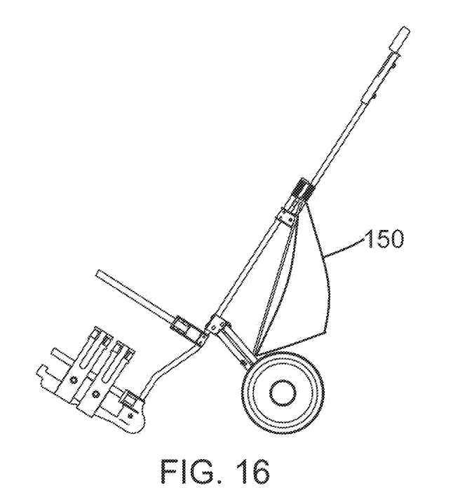

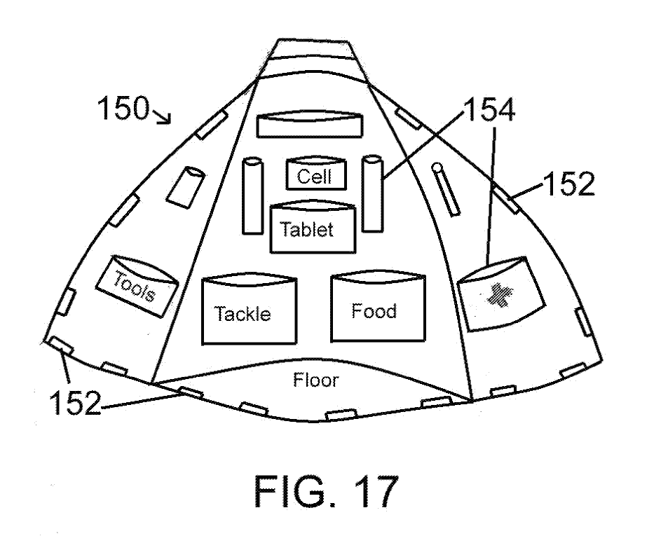

As shown in FIGS. 16 through 17, a caddie compartment bag 150 can be attached along the upper tube assembly 76. The compartment bag 150 can be attached to the tube assembly 76 in various manners provided that a user can open the compartment bag 150 to retrieve contents stored therewithin. A closing mechanism 152, such as a hook and loop fastener (such as Velco®), can be used to open and close the caddie compartment bag 150. In some embodiments, the compartment bag 150 can be made with a plurality of pockets 154. The pockets can be sized to hold various items, such as first aid supplies, phones, flash lights, tackle, tools, food and drinks (including cold packs if needed), and the like. In some embodiments, the compartment bag 150 can be made water proof. In some embodiments, one or more pockets can be made water proof, while other pockets may be made from a material through which water may flow. While FIG. 17 shows various labels for the pockets 154, the pockets 154 can be used to hold any variety of items that the user desires. The caddie compartment bag 150 can be attached to the caddie in various manners and at various locations. FIG. 7 shows one example of the mounting location of the caddie compartment bag 150 and FIG. 16 shows another example of a location for mounting the caddie compartment bag 150.

Leg braces 96 can extend from the brace arm support 94 to a wheel strut assembly 98 on each side of the caddy 70. First and second wheel struts 100, 102 can extend from the wheel strut bracket 92 of the lower tube assembly 86 (connecting at capped ends 106 of the wheel struts 100, 102) to a wheel strut lower bracket 104. Bolts 108 and nuts 110, for example, can secure the wheel struts 100, 102 to the wheel strut lower bracket 104, allowing the wheel struts 100, 102 to pivot therein. The wheels 72 can rotate about a shaft (not shown) supported by the wheel strut lower bracket 104.

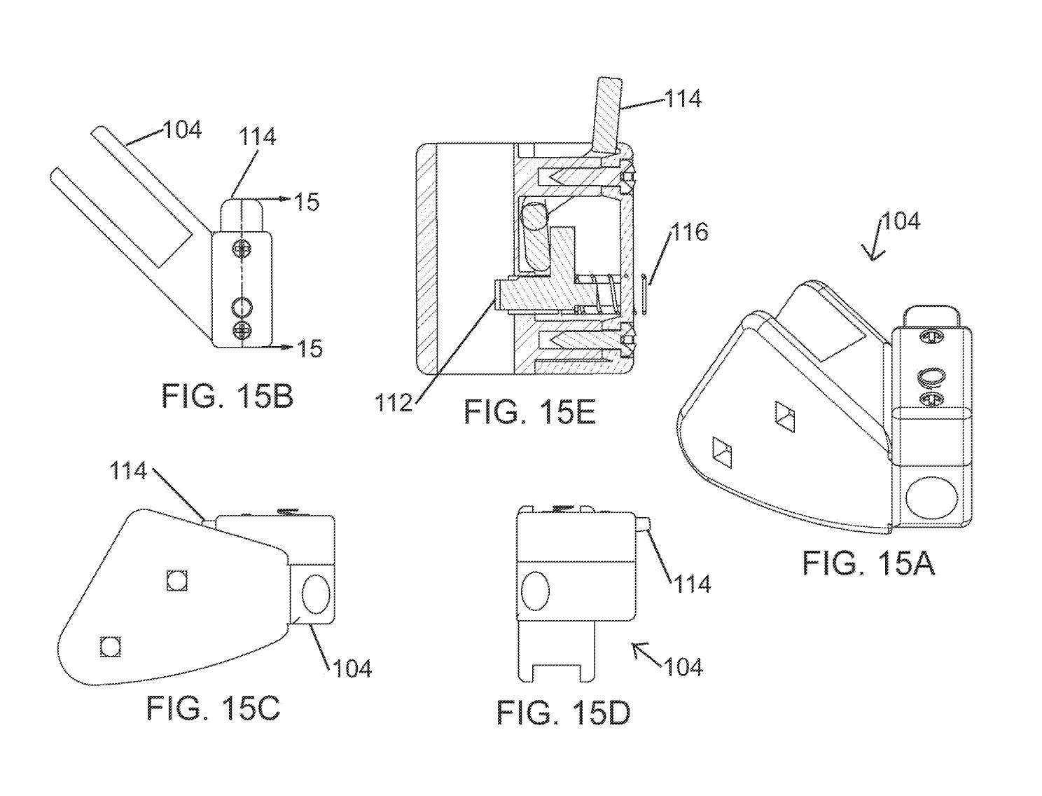

As shown in FIGS. 15A through 15E, the wheel strut lower bracket 104 can include a lock pin 112 to lock the caddy 70 in the open position, with the wheels 72 spaced apart. A user may move a latch lever 114 to release the lock pin 112 to close the caddy 70, if desired. A spring 116, for example, can keep the lock pin 112 in the locked position.

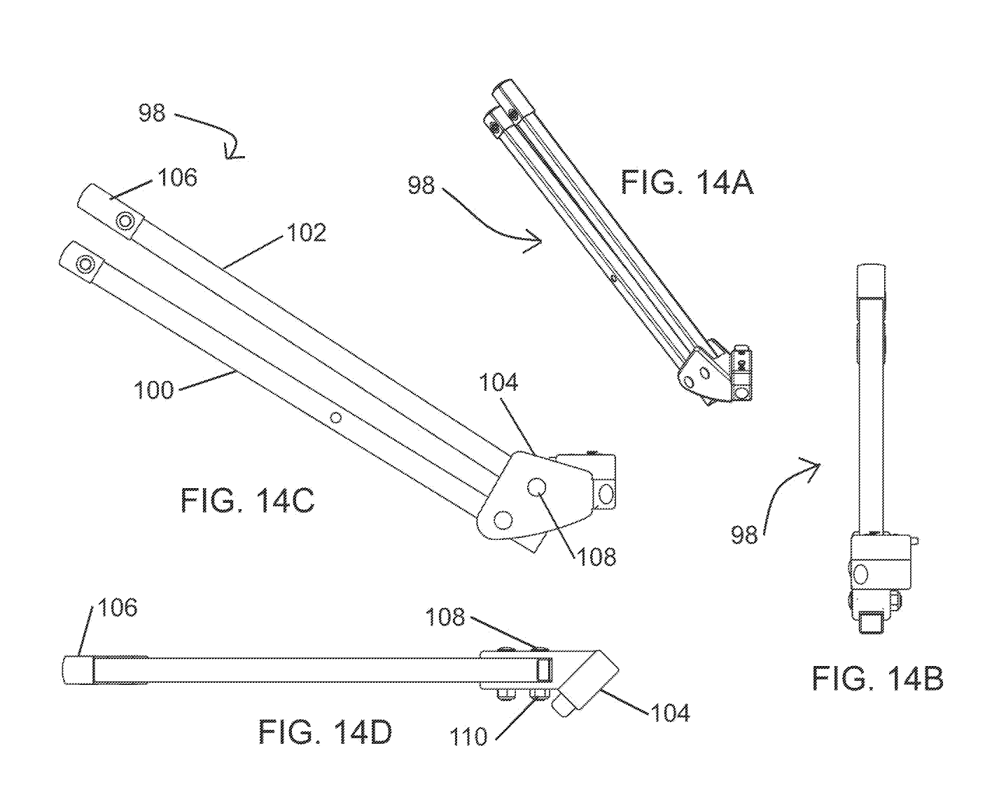

It should be noted that FIGS. 14A through 15E show the left side of the wheel strut assembly and the wheel strut lower bracket assembly. The right hand side can be designed as a mirror image of these designs.

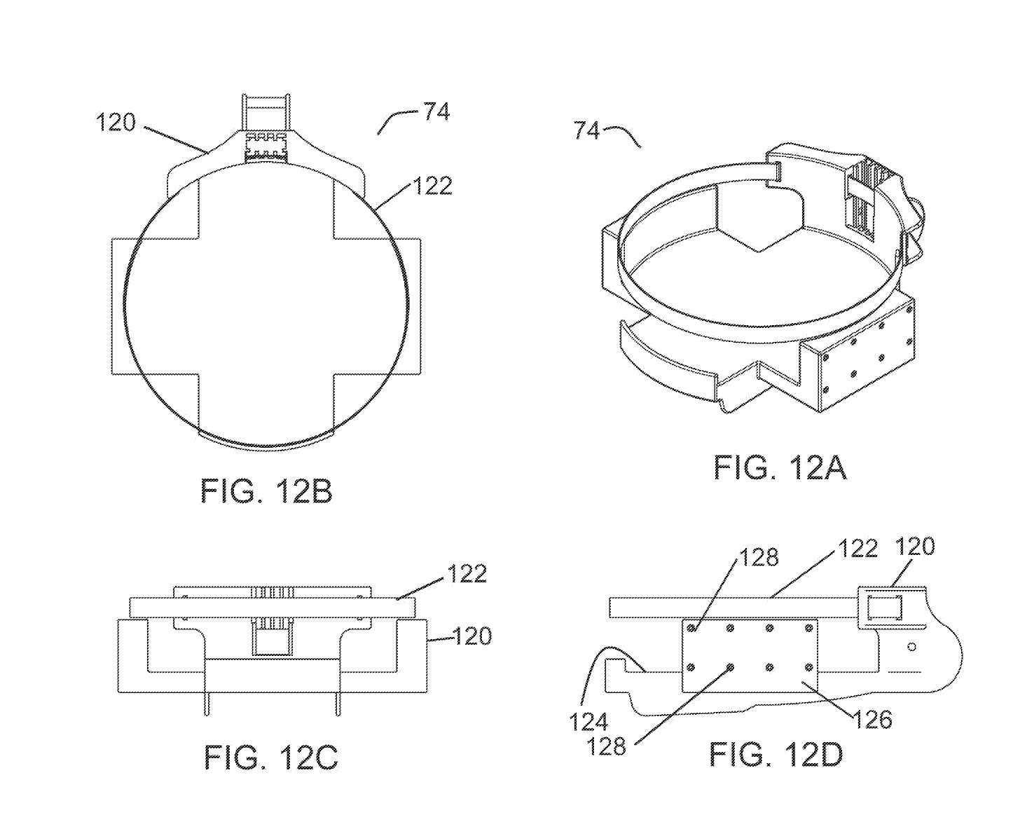

The caddy 70 can include mechanisms for holding the bucketbasket 10 thereto. For example, the caddy 70 can include the lower bucket bracket assembly 74, as shown, for example, in FIGS. 12A through 12D. The lower bucket bracket assembly 74 can include a bracket 120 for attachment to the lower tube assembly 86, and a strap 122 fitting around the bucketbasket 10. The bracket 120 can include a base member 124 for supporting a base of the bucketbasket 10, and side members 126 having a plurality of holes 128 formed therethrough. The holes 128 can be used to support rod holders 130, discussed below. As mentioned above, the base member 124 may form a rest to support the caddy 70, along with the two wheels 72, in an upright position. A user may tilt the caddy 70 onto only the two wheels 72 for movement thereof.

The caddy 70 can also include an upper bucket bracket assembly 132 having a bracket 134 for attachment to the lower tube assembly 86, and a strap 136 fitting about the bucketbasket 10. The upper bucket bracket assembly 132 can be disposed above the lower bucket bracket assembly 74 at a height that fully retains the bucketbasket 10 in place on the caddy 70.

The caddy 70 can also include rod holders 130 disposed at the side members 126 of the lower bucket bracket assembly 74. In some embodiments, two rod holders 130 can be disposed on each side of the caddy 70, as shown in the Figures. The rod holders 130 can include a base 140 that attaches to the caddy 70. A tube member 142 can pivot about the base 140. The tube member 142 can hole fishing poles therein. A lock collar 144 can be disposed about an upper opening of the tube member 142 to lock the fishing pole in place when stored therein. The tube member 142 may include teeth that engage teeth of the base 140, allowing the pivoting action to lock into various positions. A spring 146 can be used to provide a resilient force of the tube member 142 against the base 140. Various mechanisms are contemplated within the scope of the present invention for pivoting the tube member 142 along the base 140. In some embodiments, the tube member 142 may be fixed relative to the base 140.

It should be understood, of course, that the foregoing relates to exemplary embodiments of the invention and that modifications may be made without departing from the spirit and scope of the invention as set forth in the following claims.

What is claimed is:

1. A fish keeping system comprising:
a bucket having a container portion and a lid;
a net assembly adapted to fit inside the bucket;
a float ring attached to one end of the net assembly;
a first ring attached to a first end of a net extending from the float ring; and
a second ring attached to the net proximal to an opening at a second end of the net.

2. The fish keeping system of claim 1, further comprising a seat on an exterior surface of the lid.

3. The fish keeping system of claim 2, further comprising a cushion on the seat.

4. The fish keeping system of claim 1, further comprising a handle for carrying the system.

5. The fish keeping system of claim 1, further comprising a net assembly handle attached to and extending from the net assembly.

6. The fish keeping system of claim 1, further comprising a top ring connected to the float ring.

7. The fish keeping system of claim 6, wherein the first ring is attached to the top ring.

8. The fish keeping system of claim 1, further comprising a drawstring for closing the opening in the net.

9. The fish keeping system of claim 1, wherein the net, when expanded, has an inside volume larger than the volume of the bucket.

10. The fish keeping system of claim 1, wherein the float ring is a hollow plastic ring.

11. The fish keeping system of claim 1, wherein the float ring is a foam ring.

12. The fish keeping system of claim 1, wherein the second ring is formed of a material that will sink in water.

13. The fish keeping system of claim 1, wherein the lid is attached to the container portion with a hinge.

14. The fish keeping system of claim 1, wherein the bucket has a size selected from the group consisting of 3 gallons, 5 gallons and 7 gallons.

15. A fishing caddy comprising:
an upper tube assembly having a handle for moving the fishing caddy;
a lower tube assembly connected to and extending from the upper tube assembly;
first and second wheels;
a wheel strut assembly extending from the lower tube assembly to the first and second wheels;
an upper bucket bracket assembly attached to the lower tube assembly, the upper bucket bracket assembly having a strap adapted to fit about a bucket;
a lower bucket bracket assembly attached to the lower tube assembly, below the upper bucket bracket assembly, the lower bucket bracket assembly having a base for supporting the bucket when disposed therein and a strap adapted to fit about the bucket, the base further resting against a surface, with the first and second wheels, when the fishing caddy is resting upright on the surface; and
one or more fishing rod holders attached to the caddy.

16. The fishing caddy of claim 15, wherein the one or more fishing rod holders attach to sides of the lower bucket bracket assembly.

17. A fishing system comprising:
a bucketbasket comprising:
a bucket having a container portion and a lid;
a net assembly adapted to fit inside the bucket;
a float ring attached to one end of the net assembly;
a first ring attached to a first end of a net extending from the float ring;
a second ring attached to the net proximal to an opening at a second end of the net;
a cushioned seat on an exterior surface of the lid;
a handle for carrying the system; and
a net assembly handle attached to and extending from the net assembly; and
a fishing caddy comprising:
an upper tube assembly having a handle for moving the fishing caddy;
a lower tube assembly connected to and extending from the upper tube assembly;
first and second wheels;
a wheel strut assembly extending from the lower tube assembly to the first and second wheels;
an upper bucket bracket assembly attached to the lower tube assembly, the upper bucket bracket assembly having a strap adapted to fit about the bucket;
a lower bucket bracket assembly attached to the lower tube assembly, below the upper bucket bracket assembly, the lower bucket bracket assembly having a base for supporting the bucket when disposed therein and a strap adapted to fit about the bucket, the base further resting against a surface, with the first and second wheels, when the fishing caddy is resting upright on the surface; and
one or more fishing rod holders attached to the caddy.

18. The fishing system of claim 17, further comprising a drawstring for closing the opening in the net.

19. The fishing system of claim 17, wherein the net, when expanded, has an inside volume larger than the volume of the bucket.

20. The fishing system of claim 17, wherein the one or more fishing rod holders attach to sides of the lower bucket bracket assembly.
